(19) United States
(12) Patent Application Publication
(10) Pub. No.: US 2026/0204979 A1
(43) Pub. Date: Jul. 16, 2026

(54) DRIVE DEVICE

(71) Applicant: HITACHI, LTD., Chiyoda-ku, Tokyo (JP)

(72) Inventors: Tetsuya SUTO, Tokyo (JP); Akeshi TAKAHASHI, Tokyo (JP); Makoto ITO, Tokyo (JP)

(73) Assignee: HITACHI, LTD., Chiyoda-ku, Tokyo (JP)

(21) Appl. No.: 18/714,138

(22) PCT Filed: Nov. 28, 2022
(86) PCT No.: PCT/JP2022/043679

§ 371 Date: May 29, 2024

(30) Foreign Application Priority Data
Dec. 16, 2021 (JP) 2021-204049

(51) Int. Cl. H02K 7/116; F16H 1/14; F16H 48/12; H02K 11/33

(52) U.S. Cl. CPC H02K 7/1163; F16H 1/14; F16H 48/12; H02K 11/33

(57) ABSTRACT

This drive device (1) comprises: a motor (2) including a cylindrical stator (23), a cylindrical rotor (24) facing the stator (23) in the radial direction, and a stator housing (25) in which the stator (23) and the rotor (24) are housed; a bevel gear (4) that is arranged on the axis of rotation of the motor (2) and to which the driving force of the motor (2) is transmitted; and a distribution mechanism (6) that transmits the driving force of the motor (2) via the bevel gear (4). At least part of the distribution mechanism (6) is arranged at a position overlapping with the outer circumferential lower surface of the stator housing (25).

### TECHNICAL FIELD

The present invention relates to a drive device.

### BACKGROUND ART

The electrification of automobiles is progressing toward a carbon neutral and autonomous driving society. Development of an eAxle in which a motor, an inverter, and a reduction gear are integrated has been accelerated as a drive device for an electric vehicle. In the eAxle, the rotational speed is increased to increase the torque by the reduction gear. As a result, it is possible to downsize the motor and to increase the output. Therefore, in the development of the eAxle, an ultra-high speed motor is being studied.

Increasing the output of the eAxle by increasing the rotational speed of the motor, which has been a common approach, is reaching the limit due to the limitation of the rotational speeds of the motor, the bearing, and the gear. In addition, in the conventional eAxle, the position of the drive shaft and the ground clearance of a vehicle are limited, and it is therefore impossible to increase the diameter of the motor.

To address the above problems, as disclosed in PTL 1, in order to mount on a vehicle a motor whose diameter is made larger, there is a technique in which the motor is placed flat.

### CITATION LIST

### Patent Literature

PTL 1: JP 2019-122226 A

### SUMMARY OF INVENTION

### Technical Problem

However, in the technique in PTL 1, the motor is placed flat immediately above the differential device (distribution mechanism) that transmits the driving force of the motor. Therefore, there is the following problem. The height of the drive device increases, and the center of gravity of a drive device becomes accordingly higher, so that the installation position of the drive device is limited.

An object of the present invention is to provide a drive device with which it is possible to increase a degree of freedom of an installation position.

### Solution to Problem

A drive device according to an aspect of the present invention includes: a motor including: a stator having a cylindrical shape; a rotor having a cylindrical shape, the rotor being radially opposed to the stator; and a stator housing that houses the stator and the rotor; a bevel gear that is disposed on a rotation axis of the motor and that a driving force of the motor is transmitted to; and a distribution mechanism that transmits the driving force of the motor via the bevel gear, wherein at least a part of the distribution mechanism is disposed at a position overlapping an outer peripheral lower surface of the stator housing.

### Advantageous Effects of Invention

The present invention can increase a degree of freedom of an installation position of a drive device.

### BRIEF DESCRIPTION OF DRAWINGS

FIG. 1 is a configuration diagram illustrating a vehicle on which a drive device according to a first embodiment is mounted.

FIG. 2 is a component exploded perspective view illustrating the drive device according to the first embodiment.

FIG. 3 is a component exploded perspective view illustrating the drive device according the first embodiment, in which view the motor is disassembled.

FIG. 4 is a perspective view illustrating the drive device according to the first embodiment, in which view the drive device is cut in half on a longitudinal section.

FIG. 5 is a longitudinal sectional view illustrating the drive device according to the first embodiment.

FIG. 6 is a perspective view illustrating the drive device according to the first embodiment as viewed obliquely from below.

FIG. 7 is an enlarged perspective view illustrating a part of the drive device according to the first embodiment, in which view P part in FIG. 6 is enlarged.

FIG. 8 is a perspective view illustrating a drive device according to a second embodiment, in which view the drive device is cut in half on a longitudinal section.

### DESCRIPTION OF EMBODIMENTS

Hereinafter, embodiments of the present invention will be described with reference to the drawings. However, the present invention is not interpreted to be limited to the following embodiments, and the technical idea of the present invention may be realized by combining other known components. In the drawings, the same elements are denoted by the same reference signs, and redundant description will be omitted. In the drawings, direction U represents the upward direction, direction D represents the downward direction, direction F represents the frontward direction, direction B represents the backward direction, direction R represents the right direction, and direction L represents the left direction.

### <First Embodiment>

### <Overall Configuration of Vehicle 100>

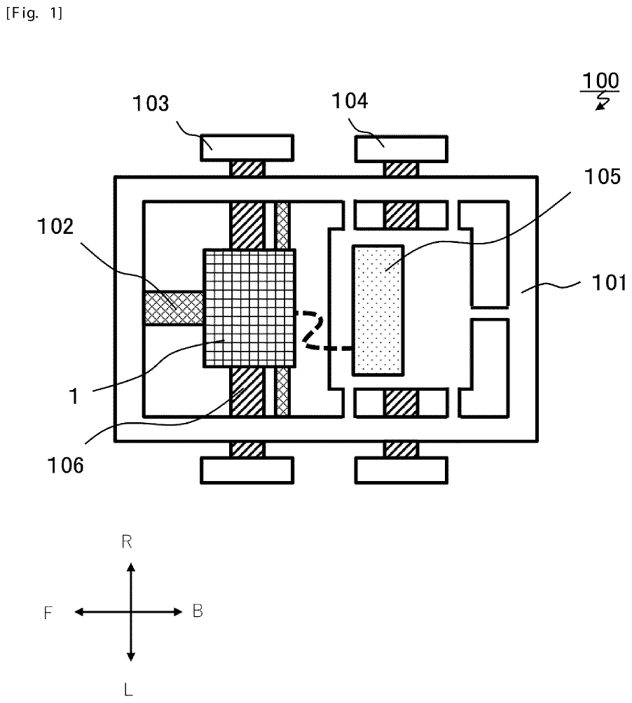

FIG. 1 is a configuration diagram illustrating a vehicle 100 on which a drive device 1 according to a first embodiment is mounted.

The vehicle 100 includes: the drive device 1 disposed at a center, a chassis 101 on which the drive device 1 is mounted, a support member 102 that fixes the drive device 1 to the chassis 101, wheels 103 that are front wheels disposed in the frontward direction F of the vehicle 100, wheels 104 that are rear wheels disposed in the backward direction B of the vehicle 100, and a battery 105 that supplies power to the drive device 1.

The drive device 1 is stored in an engine room between the wheels 103 in the frontward direction F of the vehicle 100. The drive device 1 is connected to the wheels 103 via drive shafts 106.

The drive shafts 106 couple differential side gears to the wheels. The drive shafts 106 extend in the right direction R and the left direction L. Since the suspension is movable, two constant velocity joints are provided between each drive shaft 106 and the corresponding wheel. Here, the drive shafts 106 are each defined as a portion from the drive device 1 to the corresponding first constant velocity joint.

Note that the drive device 1 may be stored between the wheels 104 in the backward direction B of the vehicle 100 to drive the wheels 104, or two drive devices may be mounted and respectively disposed between the wheels 103 and between the wheels 104 to drive the four wheels.

### <Drive Device 1>

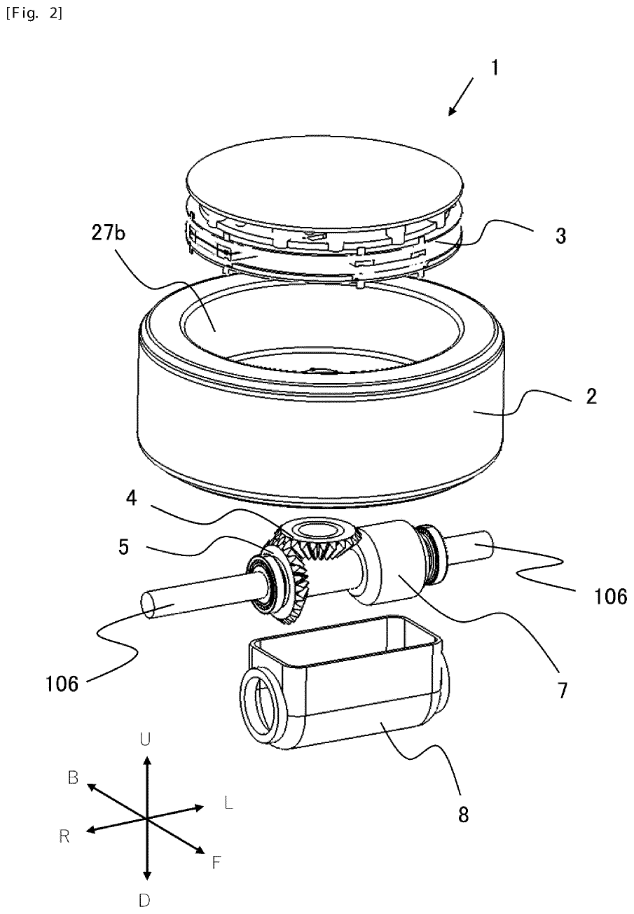

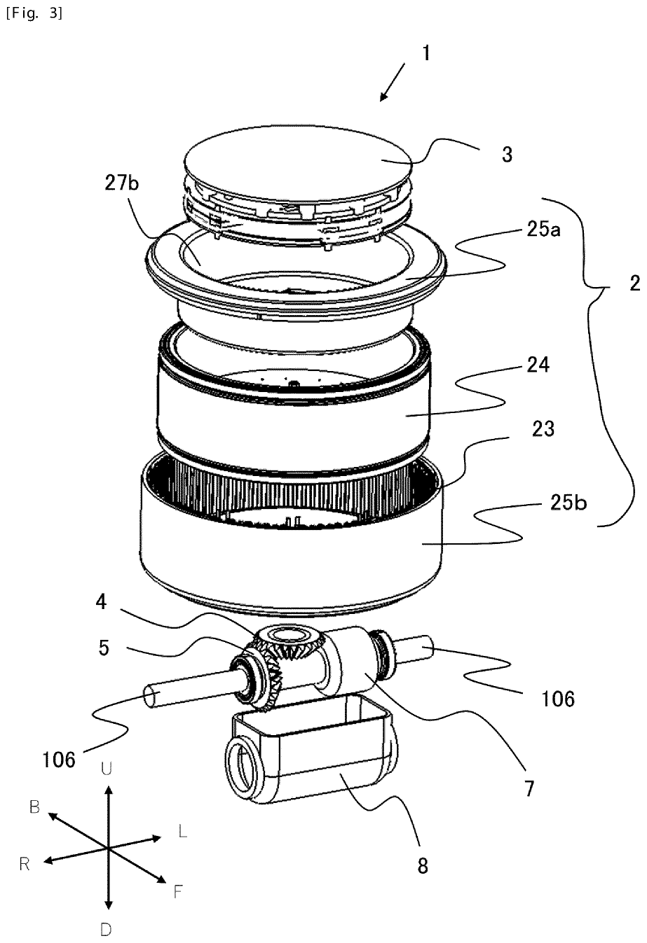

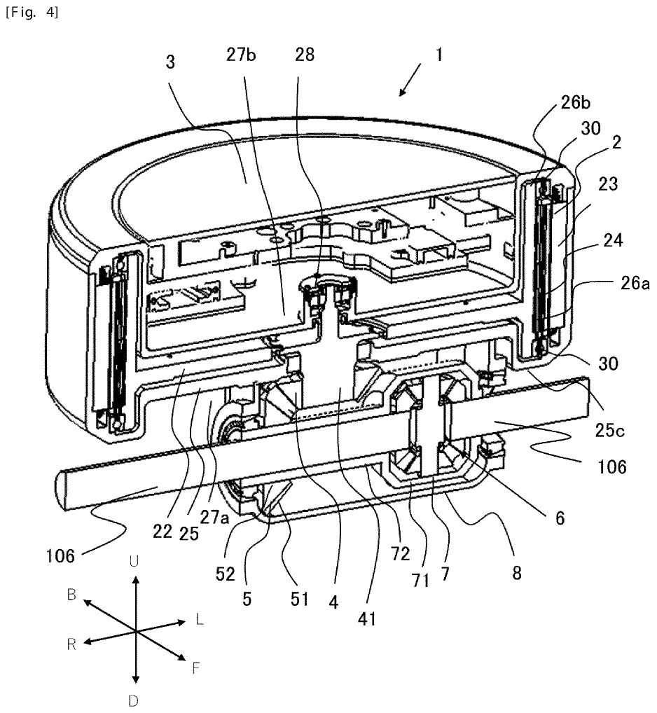

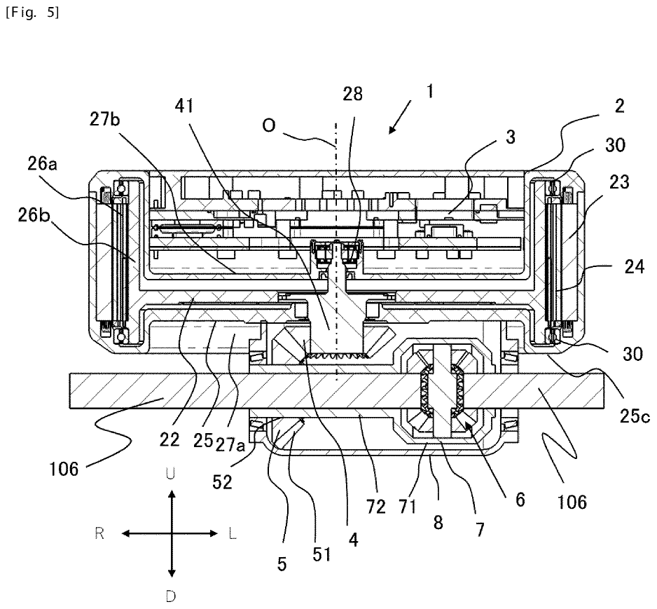

FIG. 2 is a component exploded perspective view illustrating the drive device 1 according to the first embodiment. FIG. 3 is a component exploded perspective view illustrating the drive device 1 according to the first embodiment, in which view a motor 2 is disassembled. FIG. 4 is a perspective view illustrating the drive device 1 according to the first embodiment, in which view the drive device 1 is cut in half on a longitudinal section. FIG. 5 is a longitudinal sectional view illustrating the drive device 1 according to the first embodiment.

The drive device 1 includes the motor 2, an inverter 3, a bevel gear 4, a ring gear 5, a distribution mechanism 6, a differential case 7, and a differential housing 8.

### <Motor 2>

The motor 2 includes: a rotor 24 having a rotor core 26a; a stator 23 having a stator core and a coil attached to the stator core; a rotor shaft 26b that is fixed on the inner peripheral side of the rotor 24 and rotates together with the rotor 24; a connection portion 22 that connects the rotor shaft 26b to a gear shaft 41 of the bevel gear 4 to be described later; and a stator housing 25 that houses these members.

### <Inverter 3>

The inverter 3 converts DC power supplied from the battery 105 into AC power and supplies the AC power to the motor 2.

### <Bevel Gear 4>

The bevel gear 4 is disposed on a rotation axis (rotation center axis O) of the motor 2, and a driving force of the motor 2 is transmitted to the bevel gear 4 via the connection portion 22 connected to the rotor shaft 26b. In detail, the bevel gear 4 is provided at an axially lower end of the gear shaft 41, and a rotational driving force of the rotor 24 is transmitted to the bevel gear 4.

The bevel gear 4 is connected to the rotor 24 via the connection portion 22 and the rotor shaft 26b. The bevel gear 4 is smaller in size than the ring gear 5 and serves also as a reduction gear.

As the bevel gear 4, it is possible to use a miter bevel gear that has the same number of teeth as the ring gear 5, has tooth tips inclined by 45° with respect to the rotation center, and has a reduction ratio of 1:1. However, when the miter bevel gear is used, a total mass of the bevel gear 4 and the ring gear 5 becomes large. Therefore, the bevel gear 4 is used in a combination of the bevel gear 4 and ring gear 5 of appropriate sizes.

The bevel gear 4 is classified, by the shape of the tooth tip, into a bent bevel gear (spiral bevel gear) and a straight bevel gear (straight bevel gear).

Regarding the bent bevel gear, the tooth tips each draw a curve, and it is therefore difficult to manufacture. However, the meshing ratio is further increased, so that generation of vibration and noise is reduced. However, a thrust load is generated in the axial direction in the bent bevel gear and therefore needs to be carefully used.

The thrust load in the straight bevel gear is small, and the direction of the thrust load is always only in the direction of parting. Therefore, the straight bevel gear has an advantage that the bearing structure can be simplified.

In the first embodiment, a bent bevel gear is used as the bevel gear 4. However, there is no limitation in the tooth tip shape of the bevel gear 4.

### <Gear Shaft 41>

The gear shaft 41 extends in the axial direction, which is the longitudinal direction toward the upward direction U and the downward direction D. The gear shaft 41 is a columnar member. The bevel gear 4 is fixed to the lower end of the gear shaft 41 in the downward direction D.

### <Ring Gear 5>

The ring gear 5 is disposed with its rotation center directed in the radial direction of the motor 2. The ring gear 5 is fixed to the differential case 7 and meshes with the bevel gear 4.

The ring gear 5 is disposed such that the rotation center of the ring gear 5 is directed in the left direction L, which is the gear shaft 41 side, that is, the inner diameter direction of the motor 2. The ring gear 5 includes: a gear teeth face portion 51 that is directed in the left direction L and has gear teeth at a predetermined taper angle; and an inner peripheral surface portion 52 directed to the drive shaft 106 of the gear teeth face portion 51. The inner peripheral surface portion 52 is coupled to the differential case 7.

### <Distribution Mechanism 6>

The distribution mechanism 6 transmits the driving force of the motor 2 to the drive shafts 106 via the bevel gear 4 and the ring gear 5. The distribution mechanism 6 and the ring gear 5 are disposed to face each other with the rotation axis (rotation center axis O) of the motor 2 as a center.

The distribution mechanism 6 is a mechanism that evenly distributes torque transmitted by a single shaft from the motor 2 to two drive axles of the drive shafts 106. The turning radices of the wheels 103 of the vehicle 100 during cornering are different between the inner wheel and the outer wheel. Therefore, a travel distance of the outer wheel is longer than a travel distance of the inner wheel, and the rotational speed of the outer wheel is accordingly larger. The distribution mechanism 6 transmits the same torque to both the left and right wheels 103 while giving a rotational speed difference (also referred to as differential) to the left and right wheels 103.

A general bevel gear type distribution mechanism includes a final drive gear (bevel gear 4), the ring gear 5 (final driven gear), the differential case 7, differential side gears, differential pinions, and a differential pinion shaft. The driving force from a power generation source of the motor 2 is transmitted to the ring gear 5 integrated with the differential case 7 by using the final drive gear, and the differential pinions and the differential pinion shaft rotate together with the differential case 7 to rotate the differential side gears coupled to the drive shafts 106, so that the driving force is transmitted to the drive shafts 106.

The differential pinions can rotate in addition to revolving together with the differential case 7. When the right and left drive wheels receive equal resistance from a road surface in a straight traveling state, the differential pinions revolve together with the differential case 7, thereby transmitting the driving force to the differential side gears. At this time, the differential pinions do not rotate.

When there is a difference in the resistance received by the left and right wheels 103 from the road surface, the differential pinions also rotate while revolving. The rotation of the differential pinions causes a rotational speed difference between the left and right differential side gears, so that the rotational speed difference between the left and right wheels 103 is absorbed.

### <Differential Case 7>

The differential case 7 stores the distribution mechanism 6 and transmits the driving force of the ring gear 5 to the distribution mechanism 6. The distribution mechanism 6 and the ring gear 5 are disposed with the rotation axis (rotation center axis O) of the motor 2 interposed therebetween. The differential case 7 is a cylindrical member surrounding the distribution mechanism 6 and the two drive shafts 106.

The differential case 7 includes a large cylindrical portion 71 and a small cylindrical portion 72. £ The large cylindrical portion 71 is a cylindrical member and covers the distribution mechanism 6. The small cylindrical portion 72 is a cylindrical member having a smaller diameter than the large cylindrical portion 71, and couples the inner peripheral surface portion 52, of the ring gear 5, having no teeth to the large cylindrical portion 71. As a result, the bevel gear 4 is disposed in a space surrounded by the ring gear 5, the large cylindrical portion 71, and the small cylindrical portion 72.

### <Differential Housing 8>

The differential housing 8 is opened on the upper side in a motor axial direction, which is the upward direction U, and covers the differential case 7. The opening of the differential housing 8 is covered by the stator housing 25.

### <Details of Motor 2>

### <Connection Portion 22>

The connection portion 22 connects the gear shaft 41 to the rotor 24 at the center of the rotor 24 in the axial direction. The connection portion 22 has a disk shape, and a hole portion is formed at the center of the connection portion 22. The connection portion 22 is connected to the gear shaft 41 passing through the hole portion at an inner diameter end part.

The connection portion 22 is manufactured together with the rotor shaft 26b and is made of a material (a material having a large Young's modulus) that is hardly deformed, for example, a metal or a carbon fiber composite resin. The connection portion 22 is increased in the radial rigidity by being made in a disk shape, has a function as a rib to prevent radial deformation, and, at the same time, has a function to transmit rotation.

### <Stator 23>

The stator 23 has a cylindrical shape longer in a radial direction, which is a lateral direction including the t frontward direction F, the backward direction B, the right direction R, and the left direction L, than in the axial direction.

The stator 23 is manufactured by laminating electromagnetic steel plates. Since the stator 23 has a large-diameter cylindrical shape, the stator 23 has a better material yield when a split core is used. However, it is difficult to consider a support structure for the stator 23 to withstand large torque. In the case of the integrated core, the core itself has a low material yield of material; however, when cores for the rotor 24 and other products are punched out from a disk-shaped residual portion in the inner peripheral portion of the stator core, the yield can be improved. Since the stator 23 has higher rigidity when connected in a cylindrical shape, the structural design is easier than that of a split core. The stator 23 may be made by either concentrated winding or split winding; however, since the stator 23 has a large diameter, a length of the coil is longer in the case of split winding, and the concentrated winding is therefore advantageous.

### <Rotor 24>

The rotor 24 is a cylindrical member radially opposed to the stator 23. The rotor 24 is disposed on the inner peripheral side with respect to the stator 23. That is, the rotor 24 is a cylindrical member disposed on the inner diameter side of the stator 23 and opposed to the stator 23.

The rotor 24 includes a cylindrical rotor core 26a and a plurality of magnetic pole portions arranged in a circumferential direction of the rotor core 26a. Similarly to the stator 23, the rotor 24 is manufactured by laminating electromagnetic steel plates. Since the rotor 24 has a large-diameter cylindrical shape, the rotor 24 has a better material yield when a split core is used. However, it is difficult to consider a support structure for the rotor 24 to withstand large torque. The rotor 24 is an inner-rotor type rotor and is disposed on the inner peripheral side of the stator 23, but an outer-rotor type rotor may be used. Furthermore, the rotor 24 may be an induction motor or a permanent magnet motor, and there is no limitation in the type of the rotor 24. The rotor 24 here is a permanent magnet synchronous motor.

### <Stator Housing 25>

The stator housing 25 houses the stator 23 and the rotor 24. In details, the stator housing 25 houses the gear shaft 41, the stator 23, the rotor 24, and the connection portion 22, and an axially lower end part of the gear shaft 41 protrudes in the downward direction D. The stator housing 25 has an H-shaped longitudinal section.

The stator housing 25 includes an upper half body 25a and a lower half body 25b. The upper half body 25a is a lid-shaped member covering the lower half body 25b that holds the stator 23 and the rotor 24 and has a box shape opened in the upward direction U. The lower half body 25b has an axially upper end part formed to be higher than the axially upper ends of the stator 23 and the rotor 24 in order to hold the stator 23 and the rotor 24.

The outer peripheral lower surface 25c of the stator housing 25 is disposed at a position overlapping at least a part of the distribution mechanism 6 when viewed from a direction orthogonal to the rotation axis (rotation center axis O) of the motor 2. The outer peripheral lower surface 25c of the stator housing 25 refers to a surface located on the lowermost side (drive shaft 106 side) of the stator housing 25.

The stator housing 25 is a housing that supports the stator 23, the rotor 24, bearings, and the like, and is engaged with the chassis 101. In a lower surface of the stator housing 25, there is formed a first recess 27a that is recessed upward. The differential case 7 is stored in the first recess 27a, so that the total height of the drive device 1 is reduced. In an upper surface of the stator housing 25, there is formed a second recess 27b that is recessed downward. Electric components such as the inverter 3 are stored in the second recess 27b. Since the core of the stator 23 having a cylindrical shape would be deformed by itself alone in the radial direction, the stator housing 25 needs rigidity to reduce deformation of the stator 23.

For the stator housing 25, it is desirable to use light metal such as aluminum or a magnesium alloy y for weight reduction. A structure in which a reinforcing member such as a rib is provided on the stator housing 25 to increase rigidity, the structure is compatible with aluminum or the like having high specific strength (strength per unit weight).

The stator housing 25 might be air-cooled; however, in order to increase output density, a flow path for a liquid refrigerant is provided inside the stator housing 25. The stator housing 25 is configured such that the motor 2 is cooled with a liquid refrigerant such as mineral oil or ATF, and the liquid refrigerant after cooling the motor 2 flows also to the distribution mechanism 6 to cool various gears.

<Rotor Core 26a>

The rotor core 26a has a cylindrical shape longer in a radial direction, which is a lateral direction including the frontward direction F, the backward direction B, the right direction R, and the left direction L, than in the axial direction. The rotor core 26a is manufactured by laminating electromagnetic steel plates. The rotor core 26a is configured such that a plurality of magnetic core plates each extending in a direction orthogonal to a central axis extending vertically are laminated in the axial direction.

<Rotor Shaft 26b>

The rotor shaft 26b supports the rotor 24 and is rotatably supported by the stator housing 25 via bearings 30. The rotor shaft 26b is a cylindrical member. The rotor shaft 26b extends in the axial direction. The rotor shaft 26b holds the rotor core 26a from the inner peripheral side. The connection portion 22 is connected to the center of the rotor shaft 26b in the axial direction.

An inner diameter of the rotor shaft 26b is larger than an outer diameter of the bevel gear 4. At least parts of the rotor shaft 26b and the bevel gear 4 are disposed at such positions that the at least parts of the rotor shaft 26b and the bevel gear 4 overlap each other in the radial direction, which is the lateral direction.

The rotor shaft 26b is defined as a rotating body including the bearings 30 for rotatably supporting the rotor 24. In the illustrated example, the bearings 30 are provided on the upper side and the lower side of the rotor core 26a, but may be provided only on one of the upper side and the lower side of the rotor core 26a. The rotor shaft 26b is connected to the gear shaft * of the bevel gear 4 described above via the connection portion 22. A material of the rotor shaft 26b may be carbon steel, SUS, or the like that is often used for a shaft, or otherwise, light metal such as aluminum depending on the size.

The rotor 24 has a large-diameter cylindrical shape; therefore, to prevent deformation in the radial direction, a rib extending in the radial direction is required. The rotor shaft 26b has a function to transmit rotation and a function as a rib to prevent radial deformation. Regarding the rotor 24, the rotor core 26a and the rotor shaft 26b are preferably coupled to each other, or the rotor core 26a is preferably attached to the rotor shaft 26b made of aluminum or the like also in order to reduce deformation of the rotor core 26a in the radial direction.

<First Recess 27a and Second Recess 27b>

On the radially inner peripheral side with respect to the rotor 24 on both axial sides of the stator housing 25, the pair of first recess 27a and second recess 27b both recessed in the axial direction is formed.

The first recess 27a, which is one of the pair of first recess 27a and second recess 27b, is formed by recessing the lower surface of the stator housing 25 toward the upward direction U on the axially lower side of the stator housing 25 in accordance with the rotor shaft 26b and the connection portion 22 having an H-shaped cross section. The distribution mechanism 6 is disposed in the first recess 27a. In detail, the first recess 27a stores the bevel gear 4, a part of the ring gear 5, a part of the distribution mechanism 6, and a part of the differential case 7.

The second recess 27b, which is the other of the pair of first recess 27a and second recess 27b, is formed by recessing the upper surface of the stator housing 25 toward the downward direction D on the axially upper side of the stator housing 25 in accordance with the rotor shaft 26b and the connection portion 22 having an H-shaped cross section. The inverter 3 is disposed in the second recess 27b. In detail, the inverter 3 is completely stored in the second recess 27b. An axially upper end part of the gear shaft 41 protrudes in the middle of the depth of the second recess 27b in the axial direction.

### <Resolver 28>

A resolver 28 detects a rotation angle around the axially upper end part of the gear shaft 41. The resolver 28 includes a stator and a rotor. The stator of resolver 28 is fixed to the stator housing 25. The rotor of the resolver 28 is fixed to the gear shaft 41.

### <Ribs 29>

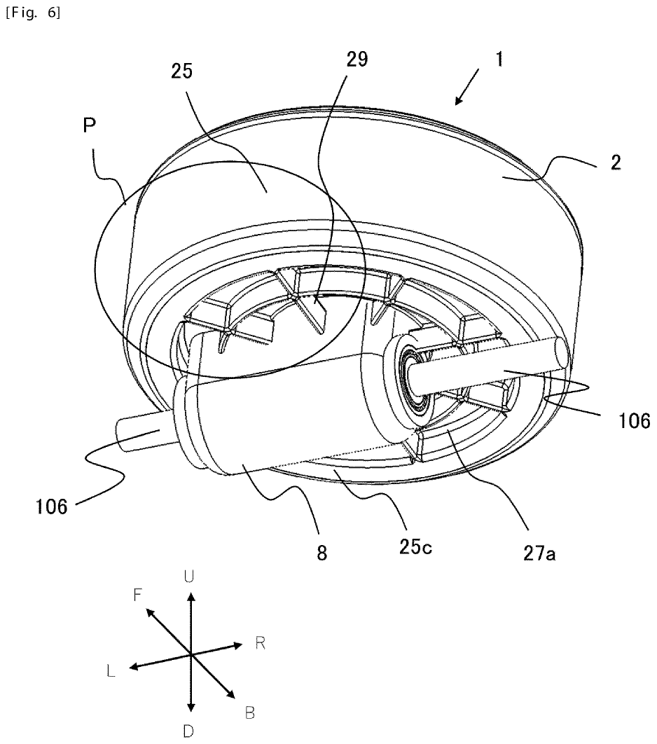

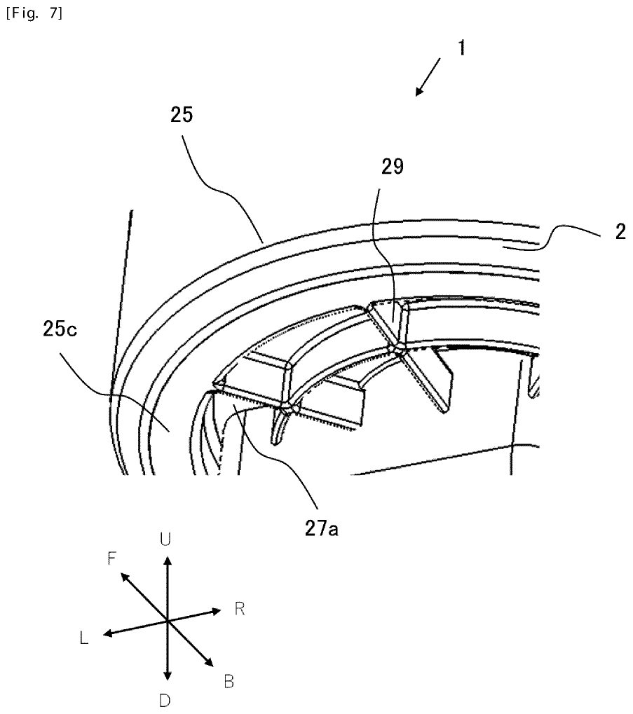

FIG. 6 is a perspective view illustrating the drive device 1 according to the first embodiment as viewed obliquely from below. FIG. 7 is an enlarged perspective view illustrating a part of the drive device 1 according to the first embodiment, in which view P part in FIG. 6 is enlarged. The ribs 29 are provided in the first recess 27a and the second recess 27b. The plurality of ribs 29 are provided extending in the radial direction around the rotation axis (rotation center axis O) of the motor 2. Ribs 29 having a cylindrical shape are also provided in the middle of the ribs 29 extending in the radial direction.

Regarding the ribs 29, the higher the rib height, the higher the rigidity. Therefore, it is important from the viewpoint of strength that the ribs 29 having a high rib height are formed in the first recess 27a and the second recess 27b that are dug as deep as possible. In order to dissipate heat from the surfaces of the ribs 29, a large number of ribs 29 are formed.

### <Advantageous Effects of First Embodiment>

With the first embodiment, a part of the distribution mechanism 6 can be embedded in the motor 2. As a result, the height and the center of gravity of the drive device 1 can be lowered, so that a degree of freedom of the installation position of the drive device 1 can be increased. With the first embodiment, a vehicle interior space can be increased, and the drive device 1 can be mounted not only on the front wheels but also on the rear wheels of the vehicle 100.

### <Second Embodiment>

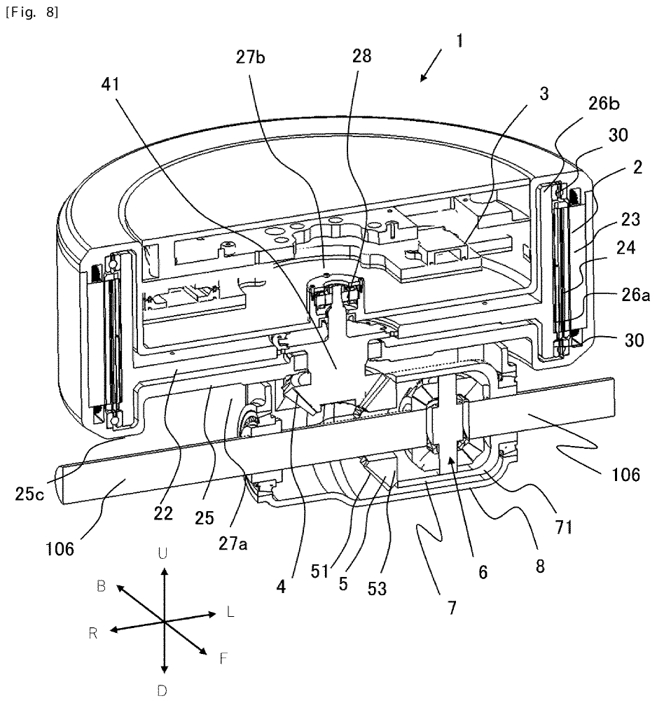

In a second embodiment, the same description as that of the above embodiment is omitted, with the same reference signs assigned. FIG. 8 is a perspective view illustrating the drive device 1 according to the second embodiment, in which view the drive device 1 is cut in half on a longitudinal section.

A ring gear 5 is directly fastened to a differential case 7. Therefore, the ring gear 5 and a distribution mechanism 6 are disposed side by side in the radial direction on one side with respect to a rotation axis (rotation center axis O) of a motor 2.

The ring gear 5 is disposed such that a rotation center of the ring gear 5 is directed to an inner diameter direction in the right direction R, which is the side of a rotation axis (rotation center axis O) of the motor 2. The ring gear 5 includes: a gear teeth face portion 51 that is directed in the right direction R and has gear teeth at a predetermined taper angle; and a radially back face portion 53 provided on the left direction L side with respect to the gear teeth face portion 51. The radially back face portion 53 has none of the teeth of the ring gear 5 and is coupled to a large cylindrical portion 71.

The large cylindrical portion 71 of the differential case 7 is connected to the radially back face portion 53, of the ring gear 5, having no teeth, and covers the distribution mechanism 6.

### <Advantageous Effects of Second Embodiment>

With the second embodiment, a conventional differential case 7 can be used as it is. In addition, the number of components of the drive device 1 can be reduced.

### <Advantageous Effects>

(A) The drive device 1 includes the motor 2. The motor 2 includes the cylindrical stator 23. The motor 2 includes the cylindrical rotor 24 radially opposed to the stator 23. The motor 2 includes the stator housing 25 that houses the stator 23 and the rotor 24. The drive device 1 includes the bevel gear 4 that is disposed on the rotation axis (rotation center axis O) of the motor 2 and that the driving force of the motor 2 is transmitted to. The drive device 1 includes the distribution mechanism 6 that transmits the driving force of the motor 2 via the bevel gear 4. At least a part of the distribution mechanism 6 is disposed at a position overlapping the outer peripheral lower surface 25c of the stator housing 25.

In this configuration, the distribution mechanism 6 is disposed to be shifted from the rotation axis (rotation center axis O) of the motor 2, so that a part of the distribution mechanism 6 can be embedded in the motor 2. As a result, the height and the center of gravity of the drive device 1 can be lowered, so that a degree of freedom of the installation position of the drive device 1 can be increased. With the above embodiments, a vehicle interior space can be increased, and the drive device 1 can be mounted not only on the front wheels but also on the rear wheels of the vehicle 100.

(B) The drive device 1 includes the motor 2. The motor 2 includes the cylindrical stator 23. The motor 2 includes the cylindrical rotor 24 radially opposed to the stator 23. The motor 2 includes the stator housing 25 that houses the stator 23 and the rotor 24. The motor 2 includes the cylindrical rotor shaft 26b that supports the rotor 24 and is rotatably supported by the stator housing 25 via bearings 30. The drive device 1 includes the bevel gear 4 that is disposed on the rotation axis (rotation center axis O) of the motor 2 and transmits the driving force of the motor 2 to the bevel gear 4 via the connection portion 22 connected to the rotor shaft 26b. The drive device 1 includes the distribution mechanism 6 that transmits the driving force of the motor 2 via the bevel gear 4. The inner diameter of the rotor shaft 26b is larger than the outer diameter of the bevel gear 4. At least parts of the rotor shaft 26b and the bevel gear 4 are disposed at such positions that the at least parts of the rotor shaft 26b and the bevel gear 4 overlap each other in the radial direction.

When the diameter of a magnetic circuit of the motor 2 is increased, it is easy to provide a space in the inner peripheral portion. However, in the technique described in PTL 1, the following components are arranged in series in the axial direction: the two bearings at both axial ends of the columnar rotor shaft; the bevel gear; and a side plate of the rotor. Therefore, it is difficult to shorten the axial length of the motor. In contrast, in the configuration of the present embodiment, the rotor shaft 26b has a cylindrical shape having an inner diameter larger than that of the bevel gear 4, and the bevel gear 4 is disposed at a position radially overlapping the rotor shaft 26b. Therefore, a part of the distribution mechanism 6 can be embedded in the motor 2. As a result, the height and the center of gravity of the drive device 1 can be lowered, so that a degree of freedom of the installation position of the drive device 1 can be increased. With the present embodiment, a vehicle interior space can be increased, and the drive device 1 can be mounted not only on the front wheels but also on the rear wheels of the vehicle 100.

(C) The drive device 1 includes the ring gear 5 that meshes with the bevel gear 4. The drive device 1 includes the differential case 7 that stores the distribution mechanism 6 and transmits a driving force of the ring gear 5 to the distribution mechanism 6. The ring gear 5 and the distribution mechanism 6 are disposed with the rotation axis (rotation center axis O) of the motor 2 interposed therebetween.

In this configuration, as compared with the case where the ring gear 5 is disposed between the rotation axis (rotation center axis O) of the motor 2 and the distribution mechanism 6, the distribution mechanism 6 can be disposed closer to the rotation axis (rotation center axis O) of the motor 2. As a result, the lengths of the left and right drive shafts 106 connected to the distribution mechanism 6 can be made to have approximately the same length.

(D) The drive device 1 includes the ring gear 5 that meshes with the bevel gear 4. The drive device 1 includes the differential case 7 that stores the distribution mechanism 6 and transmits a driving force of the ring gear 5 to the distribution mechanism 6. A ring gear 5 is directly fastened to the differential case 7.

In this configuration, the conventional differential case 7 can be used as it is. In addition, the number of components of the drive device 1 can be reduced.

(E) The rotor 24 is disposed on the inner peripheral side with respect to the stator 23.

In an outer-rotor type motor, in which the rotor 24 is disposed on the outer peripheral side with respect to the stator 23, it is necessary to dispose a connection portion connecting the rotor to the bevel gear on one side in the axial direction of the stator. In contract, the motor 2 according to the present embodiment is an inner-rotor type motor, in which the rotor 24 is disposed on the inner peripheral side with respect to the stator 23, and the connection portion 22 connecting the rotor 24 to the bevel gear 4 can be disposed on the inner peripheral side of the rotor 24. As a result, an axial length of the motor 2 can be shortened. In general, the outer-rotor type motor generates torque more easily than the inner-rotor type motor; however, even in the case of the inner-rotor type motor, it is possible to obtain an output density substantially equal to that of the outer-rotor type motor when the stator is made in a flat shape.

(F) On the radially inner peripheral side with respect to the rotor 24 on both axial sides of the stator housing 25, the pair of first recess 27a and second recess 27b both recessed in the axial direction is formed.

When the motor is made large in diameter and low in height, a rib is required to secure rigidity. In the case where a rib is provided outside the stator housing without providing a recess in the stator housing, the axial length of the motor is accordingly longer. In contrast, in the drive device 1 according to the present embodiment, the pair of first recess 27a and second recess 27b are formed on both sides of the stator housing 25 in the axial direction. Therefore, by providing the ribs 29 in the pair of first recess 27a and second recess 27b, it is possible to improve the rigidity of the motor 2 while preventing the axial length of the motor 2 from becoming long.

(G) The drive device 1 includes the inverter 3. The distribution mechanism 6 is disposed in the first recess 27a, which is one of the pair of first recess 27a and second recess 27b. The inverter 3 is disposed in the second recess 27b, which is the other of the pair of first recess 27a and second recess 27b.

This configuration makes it possible to integrate the motor 2 with the inverter 3 without increasing the height of the drive device 1. In addition, it is possible to shorten the wiring length of the three-phase lines (U, V, W) connecting between the motor 2 and the inverter 3. Furthermore, the stator housing 25 is configured as a housing of the inverter 3, so that the number of components can be reduced and the weight of the whole of the drive device 1 can be reduced.

(H) The drive device 1 includes the motor 2. The motor 2 includes the gear shaft 41 extending in the axial direction, which is the longitudinal direction. The motor 2 includes the cylindrical stator 23 that is longer in the radial direction, which is the lateral direction, than in the axial direction. The motor 2 includes the cylindrical rotor 24 that is disposed on the inner diameter side with respect to the stator 23 and is opposed to the stator 23. The motor 2 includes the disk-shaped connection portion 22 that connects the gear shaft 41 to the rotor 24 at the center of the rotor 24 in the axial direction. The motor 2 includes the stator housing 25 that stores the gear shaft 41, the stator 23, the rotor 24, and the connection portion 22 and from which an axially lower end of the gear shaft 41 protrudes. In detail, the drive device 1 includes the bevel gear 4 that is provided at the axially lower end of the gear shaft 41 and that the driving force of the rotor 24 is transmitted to. The drive device 1 includes the ring gear 5 that meshes with the bevel gear 4. The drive device 1 includes the distribution mechanism 6 that transmits the driving force of the motor 2 via the bevel gear 4 and the ring gear 5. The drive device 1 includes the differential case 7 that stores the distribution mechanism 6 and transmits a driving force of the ring gear 5 to the distribution mechanism 6. On the axially lower side of the stator housing 25, the first recess 27a is formed by recessing the axially lower side of the stator housing 25 in the upward direction U in accordance with the rotor 24 and the connection portion 22 in the stator housing 25. The first recess 27a stores the bevel gear 4, a part of the ring gear 5, a part of the distribution mechanism 6, and a part of the differential case 7.

In this configuration, the bevel gear 4, a part of the ring gear 5, a part of the distribution mechanism 6, and a part of the differential case 7 can be embedded and stored in the first recess 27a formed in the lower surface of the stator housing 25. As a result, the height and the center of gravity of the drive device 1 can be lowered, so that a degree of freedom of the installation position of the drive device 1 can be increased. With the present embodiment, a vehicle interior space can be increased, and the drive device 1 can be mounted not only on the front wheels but also on the rear wheels of the vehicle 100.

(I) The ring gear 5 and the distribution mechanism 6 are disposed to face each other with the rotation axis (rotation center axis O) of the motor 2 as a center. The ring gear 5 is disposed with its rotation center directed to the radial direction. The differential case 7 includes: the large cylindrical portion 71 that covers the distribution mechanism 6; and the small cylindrical portion 72 that has a smaller diameter than the large cylindrical portion 71 and connects the inner peripheral surface portion 52, of the ring gear 5, having no teeth to the large cylindrical portion 71.

In this configuration, the ring gear 5 and the differential case 7 are disposed with the rotation axis (rotation center axis O) of the motor 2 interposed therebetween, so that the differential case 7 can be disposed closer to the center of the vehicle 100, and the left and right drive shafts 106 extending from the distribution mechanism 6 are provided having approximately the same length. In addition, since the differential case 7 has the small cylindrical portion 72 that connects the inner peripheral surface portion 52, of the ring gear 5, having no teeth to the large cylindrical portion 71, the differential case 7 can bridge over the bevel gear 4 provided at the axially lower end of the gear shaft 41 without increasing the size of the differential case 7 toward the upward direction U or the downward direction D in the axial direction.

(J) The bevel gear 4 is disposed in a space surrounded by the ring gear 5, the large cylindrical portion 71, and the small cylindrical portion 72.

In this configuration, even when the bevel gear 4 protrudes from the stator housing 25, the bevel gear 4 is disposed in the space in the first recess 27a surrounded by the ring gear 5, the large cylindrical portion 71, and the small cylindrical portion 72. As a result, the bevel gear 4 can be embedded in the motor 2. Furthermore, even when the bevel gear 4 and the small cylindrical portion 72 are arranged in the axial direction, the whole of the drive device 1 does not become higher in the axial direction.

(K) The ring gear 5 and a distribution mechanism 6 are disposed side by side in the radial direction on one side with respect to the rotation axis (rotation center axis O) of the motor 2. The ring gear 5 is disposed with its rotation center directed to the radial direction. The differential case 7 is connected to the radially back face portion 53, of the ring gear 5, having no teeth, and includes the large cylindrical portion 71 covering the distribution mechanism 6.

In this configuration, since the ring gear 5 is directly fastened to the differential case 7, the conventional differential case 7 can be used as it is. In addition, the number of components of the drive device 1 can be reduced.

(L) The drive device 1 includes the differential housing 8 that is open on the axially upper side and covers the differential case 7. The opening of the differential housing 8 is covered by the stator housing 25.

In this configuration, the stator housing 25 serves also as the differential housing 8. Therefore, the number of components is reduced, and the overall weight of the drive device 1 can be reduced.

(M) On the axially upper side of the stator housing 25, the second recess 27b is formed by recessing the axially upper side of the stator housing 25 in the downward direction D in accordance with the rotor 24 and the connection portion 22 in the stator housing 25. The inverter 3 is stored in the second recess 27b.

In this configuration, the motor 2 and the inverter 3 can be integrated without increasing the height. Furthermore, it is possible to shorten the wiring length of the three-phase lines (U, V, W) connecting between the motor 2 and the inverter 3. In addition, the stator housing 25 serves also as a housing of the inverter 3. Therefore, the number of components is reduced, and the overall weight of the drive device 1 can be reduced.

(N) The axially upper end part of the gear shaft 41 protrudes to the middle of the depth of the second recess 27b in the axial direction. £ The drive device 1 includes the resolver 28 that includes a stator and a rotor. The stator is fixed to the housing 25, and the rotor is fixed to the gear shaft 41.

This configuration enables the resolver 28 to detect the rotation angle around the axially upper end part of the gear shaft 41.

(O) The resolver 28 detects the rotation angle around the axially upper end part of the gear shaft 41.

In this configuration, the wiring lines of resolver 28 are stored in the second recess 27b in the same manner as the wiring lines of the three-phase lines (U, V, W) to the inverter 3, so that the wiring lines can be simply routed. The electrical system related to the motor 2 is collected in the second recess 27b on the upper side of the motor 2.

Although the embodiments of the present invention have been described above, the above embodiments merely illustrate a part of the application example of the present invention, and the technical scope of the present invention is not intended to be limited to the specific configuration of the above embodiments.

### REFERENCE SIGNS LIST

1 drive device
2 motor
3 inverter
4 bevel gear
5 ring gear
6 distribution mechanism
7 differential case
8 differential housing
22 connection portion
23 stator
24 rotor
25 stator housing
25a upper half body
25b lower half body
26a rotor core
26b rotor shaft
27a first recess
27b second recess
28 resolver
29 rib
41 gear shaft
51 gear teeth face portion
52 inner peripheral surface portion
53 radially back face portion
71 large cylindrical portion
72 small cylindrical portion
100 vehicle
101 chassis
102 support member
103 wheel
104 wheel
105 battery
106 drive shaft

1. A drive device comprising:
a motor including:
a stator having a cylindrical shape;
a rotor having a cylindrical shape, the rotor being radially opposed to the stator; and
a stator housing that houses the stator and the rotor;
a bevel gear that is disposed on a rotation axis of the motor and that a driving force of the motor is transmitted to; and
a distribution mechanism that transmits the driving force of the motor via the bevel gear,
wherein at least a part of the distribution mechanism is disposed at a position overlapping an outer peripheral lower surface of the stator housing.

2. A drive device comprising:
a motor including:
a stator having a cylindrical shape;
a rotor having a cylindrical shape, the rotor being radially opposed to the stator;
a stator housing that houses the stator and the rotor; and
a rotor shaft having a cylindrical shape, the rotor shaft supporting the rotor and being rotatably supported by the stator housing via a bearing;
a bevel gear that is disposed on a rotation axis of the motor and that a driving force of the motor is transmitted to, via a connection portion connected to the rotor shaft; and
a distribution mechanism that transmits the driving force of the motor via the bevel gear,
wherein an inner diameter of the rotor shaft is larger than an outer diameter of the bevel gear, and
at least parts of the rotor shaft and the bevel gear are disposed at such positions that the at least parts of the rotor shaft and the bevel gear radially overlap each other.

3. The drive device according to claim 1, further comprising:
a ring gear that meshes with the bevel gear; and
a differential case that stores the distribution mechanism and transmits a driving force of the ring gear to the distribution mechanism,
wherein the ring gear and the distribution mechanism are disposed with the rotation axis of the motor interposed between the ring gear and the distribution gear.

4. The drive device according to claim 1, further comprising:
a ring gear that meshes with the bevel gear; and
a differential case that stores the distribution mechanism and transmits a driving force of the ring gear to the distribution mechanism,
wherein the ring gear is directly fastened to the differential case.

5. The drive device according to claim 1,
wherein the rotor is disposed on an inner peripheral side with respect to the stator.

6. The drive device according to claim 1,
wherein a pair of recesses recessed in an axial direction is formed on radially inner peripheral side with respect to the rotor on both axial sides of the stator housing.

7. The drive device according to claim 6, further comprising
an inverter,
wherein the distribution mechanism is disposed in a first one of the pair of recesses, and the inverter is disposed in a second one of the pair of recesses.
